(19) United States
(12) Patent Application Publication
(10) Pub. No.: US 2014/0297981 A1
(43) Pub. Date: Oct. 2, 2014

(54) INFORMATION PROCESSING SYSTEM, STORAGE DEVICE, AND BACKUP METHOD

(71) Applicant: FUJITSU LIMITED, Kawasaki-shi (JP)

(72) Inventors: Shinichi KAMEYAMA, Iwakura (JP); Tetsuya Hibino, Nagoya (JP)

(73) Assignee: FUJITSU LIMITED, Kawasaki-shi (JP)

(21) Appl. No.: 14/199,119

(22) Filed: Mar. 6, 2014

(30) Foreign Application Priority Data
Mar. 26, 2013 (JP) 2013-063855

(51) Int. Cl. G06F 3/06

(52) U.S. Cl. CPC G06F 3/065; G06F 3/0604; G06F 3/0673; G06F 3/0662
USPC 711/162

(57) ABSTRACT

An information processing system includes a processing device; and a storage device that is accessed by the processing device. The storage device includes a storage unit, and a processor coupled to the storage unit. The processor is configured to build a virtual device, determine an I/O request to the virtual device from the processing device, as a copy request to the storage unit, and execute a copy instruction to the storage unit in response to the copy request.

### CROSS-REFERENCE TO RELATED APPLICATION

This application is based upon and claims the benefit of priority of the prior Japanese Patent Application No. 2013-063855 filed on Mar. 26, 2013, the entire contents of which are incorporated herein by reference.

### FIELD

The embodiments discussed herein are related to an information processing system, a storage device, and a backup method.

### BACKGROUND

When a backup instruction (copy instruction) is executed to a storage device from a computer, a backup instruction by a specific command (vendor specific small computer system interface (SCSI) command) to the storage device or a backup instruction by specifying an internet protocol (IP) address is executed.

In a virtual system that provides an operation of a virtual machine for a user, from a viewpoint of security, it is desirable that the system is managed in a state in which information on hardware that supports a virtual system environment is not disclosed to the user as much as possible. That is, in the management of the virtual system, from the viewpoint of security, it is not appropriate that an IP address or the name of an actual device that is allowed to access a storage device directly is provided for the user of the virtual machine to allow the user to execute backup processing (copy processing).

In addition, recently, from the viewpoint of security, the direct access to the storage device from the virtual machine has been widely prohibited by a hypervisor that builds the virtual machine. For example, as illustrated in FIG. 16, a copy instruction to a storage device from a virtual environment A on a virtual host by a vendor specific SCSI command is blocked (limited) by the hypervisor. As a related art, Japanese National Publication of International Patent Application No. 2007-533030 is known.

### SUMMARY

According to an aspect of the invention, an information processing system includes a processing device; and a storage device that is accessed by the processing device. The storage device includes a storage unit, and a processor coupled to the storage unit. The processor is configured to build a virtual device, determine an I/O request to the virtual device from the processing device, as a copy request to the storage unit, and execute a copy instruction to the storage unit in response to the copy request.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of an information processing system and a storage device according to an embodiment;

FIG. 2 is a diagram illustrating a function configuration of a host and the storage device according to the embodiment;

FIG. 3 is an example illustrating a policy information table according to the embodiment;

FIG. 4 is an example illustrating a session information table according to the embodiment;

FIG. 5 is a diagram illustrating an operation of the host;

FIG. 6A is a diagram illustrating a regular write request and data that is written by the write request, and FIG. 6B is a diagram illustrating a regular read request and a data that is read by the read request;

FIG. 7 is a diagram illustrating a function of the information processing system according to the embodiment;

FIG. 8 is a diagram illustrating a creation procedure of the policy information table in the information processing system according to the embodiment;

FIG. 9 is a flowchart illustrating an operation of a virtual machine in the information processing system according to the embodiment;

FIG. 10 is a diagram illustrating a write/read instruction and data that are transmitted and received between a virtual machine and the storage device in the information processing system according to the embodiment;

FIG. 11 is a flowchart illustrating an operation of the storage device in the information processing system according to the embodiment;

FIG. 12 is a flowchart illustrating copy processing in FIG. 11;

FIG. 13 is a flowchart illustrating release processing in FIG. 11;

FIG. 14 is a flowchart illustrating read processing in FIG. 11;

FIGS. 15A and 15B are diagrams illustrating detailed validity determination of a command content using the policy information table according to the embodiment; and

FIG. 16 is a diagram illustrating block (limit) of a copy instruction from the virtual machine to the storage device.

### DESCRIPTION OF EMBODIMENTS

In the embodiments, a copy instruction from a virtual environment to storage device may be executed while the security is ensured similar to a regular environment.

The embodiments are described below with reference to the drawings.

### 1 CONFIGURATION IN AN EMBODIMENT

### 1-1 Hardware Configuration of an Information Processing System and a Storage Device

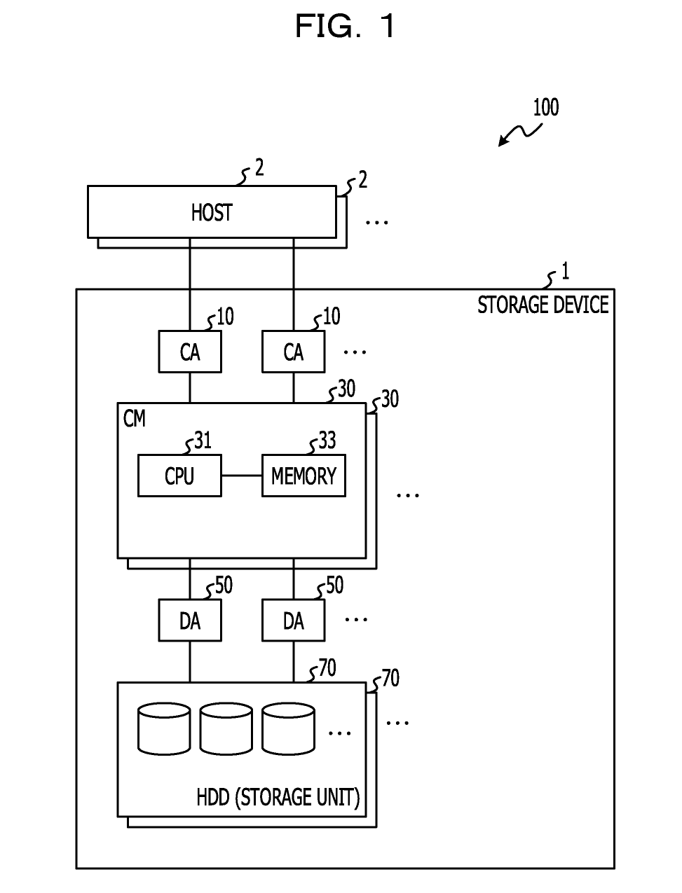

FIG. 1 illustrates a hardware configuration of an information processing system 100 and a storage device 1 according to the embodiment.

As illustrated in FIG. 1, the information processing system 100 according to the embodiment includes the storage device 1 and a host computer (processing device: hereinafter simply referred to as “host”) 2 that accesses the storage device 1. The storage device 1 is, for example, a disk array device (redundant arrays of inexpensive disks (RAID) device), receives various requests from the host 2, and executes various pieces of processing that correspond to the requests. The storage device 1 includes a plurality of channel adapters (CAs) 10, a plurality of controller modules (CMs) 30, a plurality of device adapters (DAs) 50, and a plurality of hard disk drives (HDDs: storage unit) 70.

Each of the CAs 10 performs interface control with the host 2 and performs data communication with the host 2. Each of the DAs 50 performs interface control with the HDD 70 and performs data communication with the HDD 70.

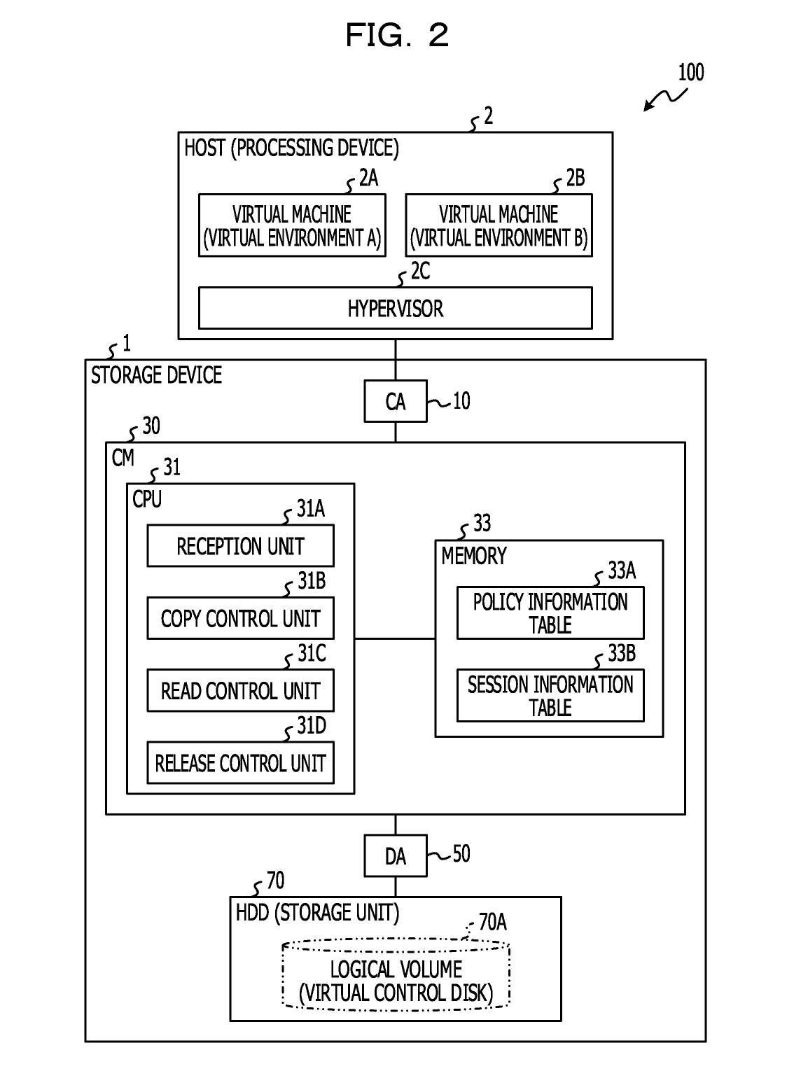

Each of the CMs 30 is provided between the CA 10 and the DA 50, and controls resources in the storage device 1, and each of the CMs 30 includes a central processing unit (CPU) 31 and a memory 33. The CPU 31 performs various types of control by executing processing in accordance with an operating system (OS) or the like, and fulfills a function that is described later with reference to FIG. 2 by executing a program that is stored in the memory 33. The memory 33 stores the tables 33A and 33B, and the like that are described later with reference to FIG. 2 in addition to the above-described program. In addition, the memory 33 functions as a cache memory that temporarily stores data that is written from the host 2 to the HDD 70 and data that is read from the HDD 70 to the host 2.

Each of the HDDs 70 stores user data that is accessed and used by the host 2, various pieces of control information, and the like. In the storage device 1 according to the embodiment, the HDD 70 is employed as a storage unit, but another type of storage device such as a solid state drive (SSD) may be employed. In addition, in FIG. 1, the plurality of CAs 10, the plurality of CMs 30, the plurality of DAs 50, the plurality of HDDs 70, and the plurality of hosts 2 are illustrated, but the number of units is arbitrary.

### 1-2 Function Configuration of the Host and the Storage Device

A function configuration and the like of the host 2 and the storage device 1 according to the embodiment is described below with reference to FIGS. 2 to 8.

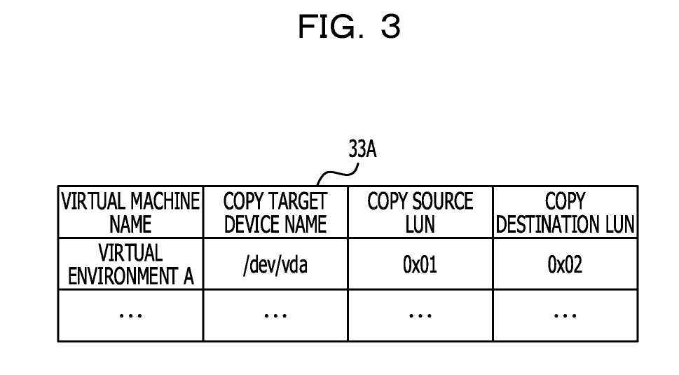

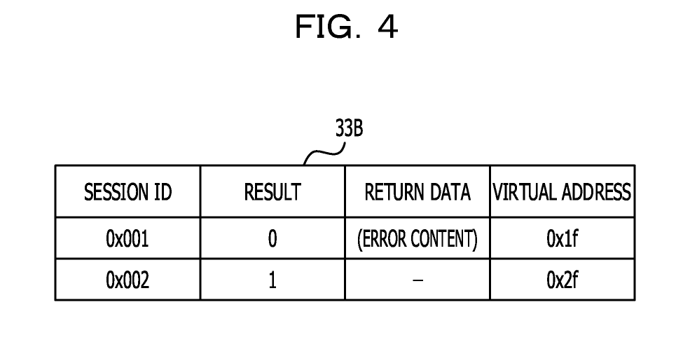

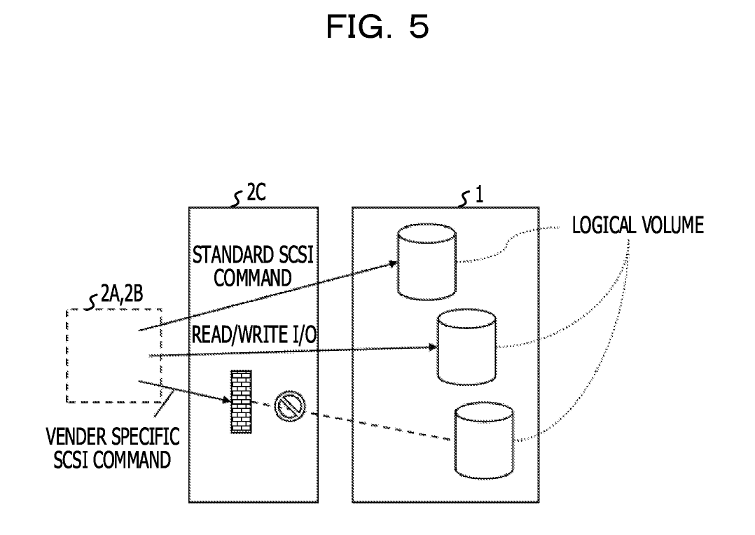

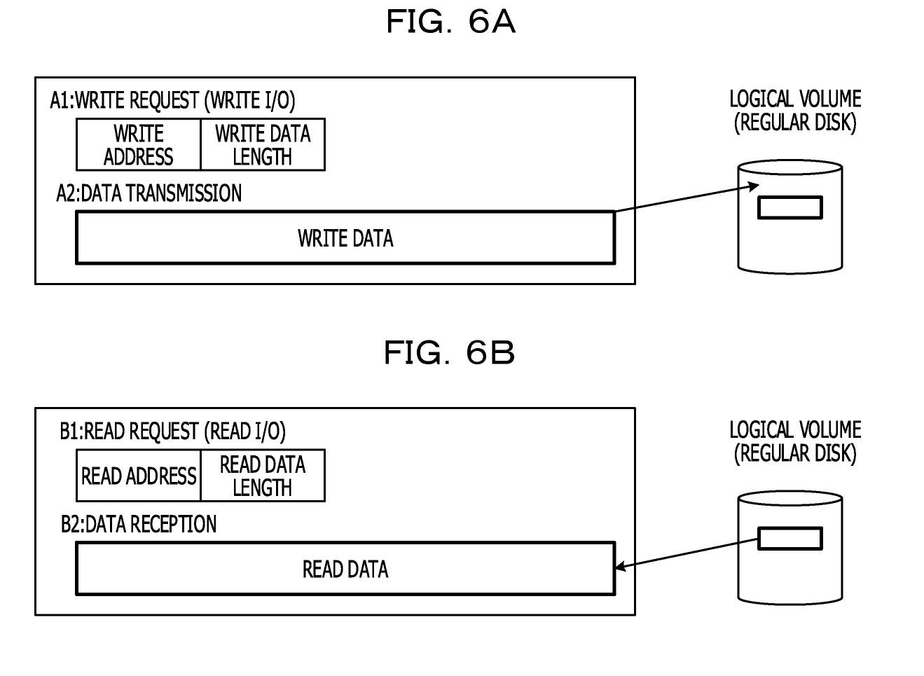

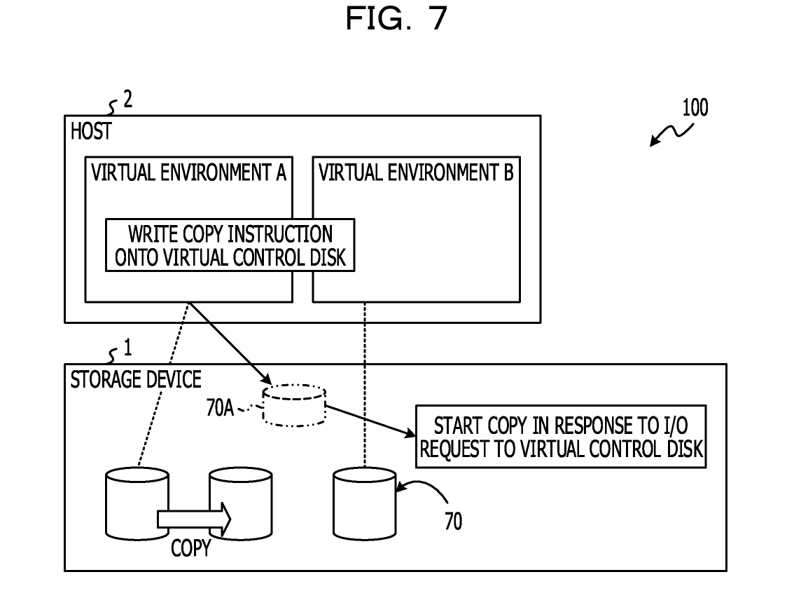

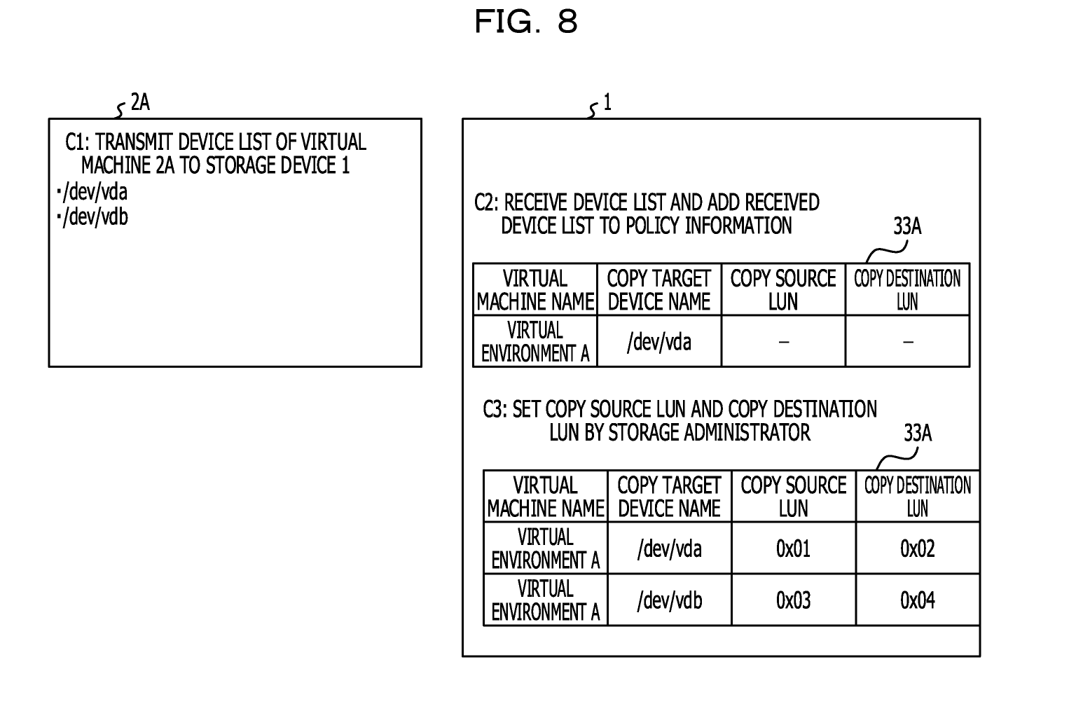

Here, FIG. 2 illustrates the function configuration of the host 2 and the storage device 1 according to the embodiment. FIG. 3 illustrates an example of the policy information table 33A according to the embodiment. FIG. 4 illustrates an example of the session information table 33B according to the embodiment. FIG. 5 is a diagram illustrating an operation of the host 2. FIG. 6A is a diagram illustrating a regular write request and data that is written by the write request, and FIG. 6B is a diagram illustrating a regular read request and data that is read by the read request. FIG. 7 is a diagram illustrating a function of the information processing system 100 according to the embodiment. FIG. 8 is a diagram illustrating a creation procedure of the policy information table 33A in the information processing system 100 according to the embodiment. In FIG. 2, the single CA 10, the single CM 30, the single DA 50, the single HDD 70, and the single host 2 are illustrated, the number of units is arbitrary.

<1-2-1> Function of the Host

As illustrated in FIG. 2, in the host 2, the two virtual machines 2A and 2B are built by a hypervisor 2C. In the embodiment, the virtual machines 2A and 2B may be respectively referred to as “virtual environment A” and “virtual environment B” that are names that are used to identify the virtual machine 2A or 2B. In addition, a case is described below in which the number of virtual machines is 2, but the embodiment is not limited to such a case.

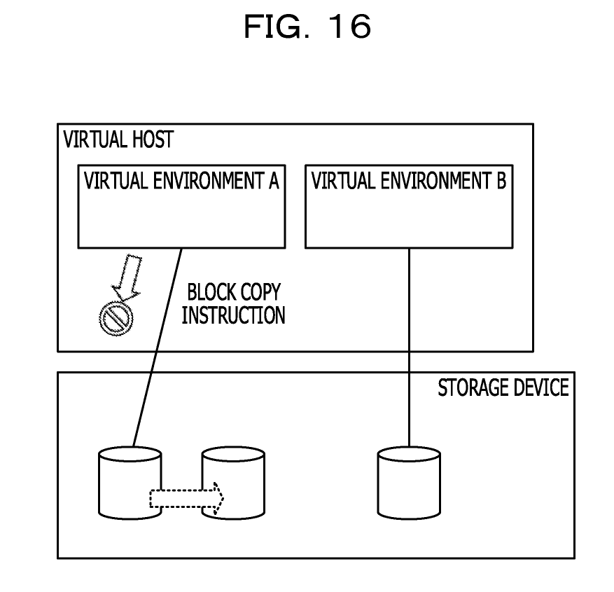

In backup software that uses a copy function of the storage device 1, generally, a copy instruction is executed to the storage device 1 by issuing a vendor specific SCSI command through a storage area network (SAN). However, as illustrated in FIGS. 5 and 16, in a virtual environment (HYPER-V (registered trademark), Solaris zone, or the like), from the view point of security, the copy instruction by the vendor specific SCSI command is blocked by the hypervisor 2C. Therefore, in the backup software of the virtual environments A and B, the copy instruction to the storage device 1 may not be executed.

However, as illustrated in FIG. 5, each of the virtual machines 2A and 2B may issue a standard SCSI command or an I/O request (read/write request: read/write I/O) to a logical volume of the storage device 1 through the hypervisor 2C. Data that is transmitted and received when each of the virtual machines 2A and 2B performs reading/writing by issuing a regular read request/write request is illustrated FIGS. 6A and 6B. In the case of writing of data, each of the virtual machines 2A and 2B issues, to the storage device 1, a write request (write I/O) that includes a write address in the logical volume (regular disk) and the data length of the write data (see A1 in FIG. 6A). After that, each of the virtual machines 2A and 2B transmits the write data to the storage device 1 to write the data onto the specified write address of the logical volume (see A2 in FIG. 6A). In addition, in the case of reading of data, the virtual machines 2A and 2B issue, to the storage device 1, a read request (read I/O) that includes a read address in the logical volume (regular disk) and the data length of the read data (see B1 in FIG. 6B). After that, each of the virtual machines 2A and 2B reads and receives data having the specified data length portion from the specified read address of the logical volume (regular disk) in the storage device 1 (see B2 in FIG. 6B).

Therefore, each of the virtual machines 2A and 2B according to the embodiment executes a copy request, a read request, or a release request to the storage device 1 using a regular write request/read request.

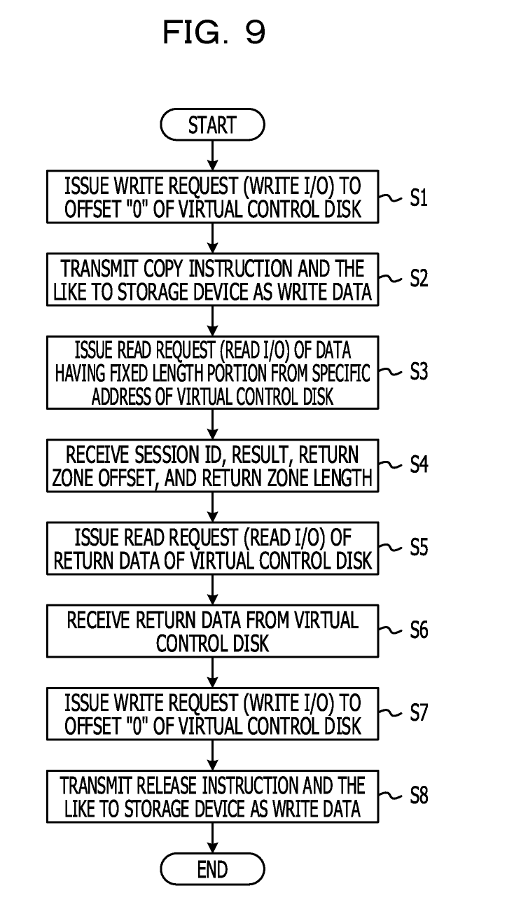

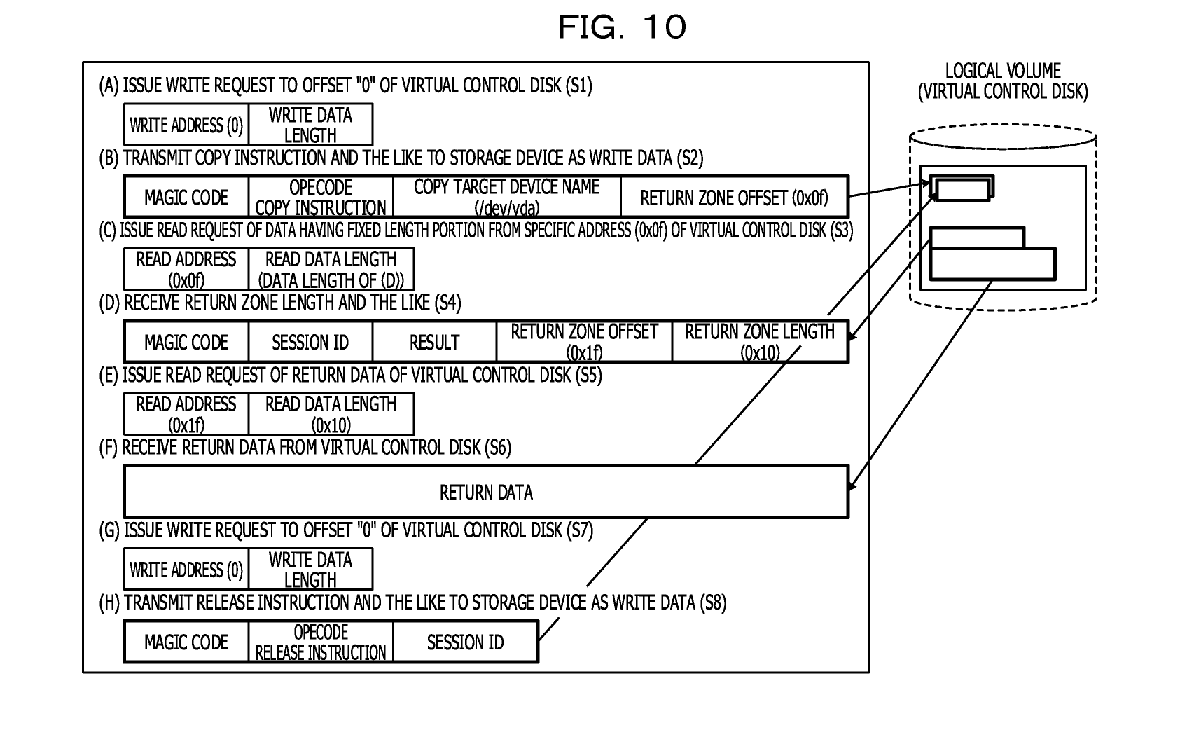

When the copy instruction is executed, as described later with reference to FIGS. 9 and 10, each of the virtual machines 2A and 2B issues a first write request that is used to specify the offset “0” of a virtual control disk 70A, which is described later as a write address (see (A) of FIG. 10). After that, each of the virtual machines 2A and 2B transmits, to the storage device 1, the content of the copy request as first write data, and writes the content onto the specified write address (offset “0” of the virtual control disk 70A). The content of the copy request includes a MagicCode, an OpeCode (copy instruction), a copy target device name, and a return zone offset that are described later ((B) of FIG. 10). As illustrated in FIG. 7, when such a first write request and first write data are accepted by a reception unit 31A in the storage device 1, which is described later, and written onto the offset “0” of the virtual control disk 70A, the copy processing is started in the HDD 70 by a copy control unit 31B in the storage device 1, which is described later.

In addition, when data that is related to the virtual control disk 70A is read, as described later with reference to FIGS. 9 and 10, each of the virtual machines 2A and 2B issues a read request that is used to specify a specific address of the virtual control disk 70A as a read address (see (C) and (E) of FIG. 10). After that, each of the virtual machines 2A and 2B reads and receives data having the specified data length portion from the specified read address. At this time, the content of the received read data includes return data that is described later (see (F) of FIG. 10) in addition to a session ID, a result, a return zone offset, a return zone length that are described later (see (D) of FIG. 10).

In addition, when the area that has been used for the copy instruction in the storage device 1 after the copy processing that corresponds to the copy request is released, as described later with reference to FIGS. 9 and 10, each of the virtual machines 2A and 2B issues a second write request that is used to specify the offset “0” of the virtual control disk 70A as a write address (see (G) of FIG. 10). After that, each of the virtual machines 2A and 2B transmits, to the storage device 1, information that is related to the release, as second write data, and writes the information onto the specified write address (offset “0” of the virtual control disk 70A). The information that is related to the release includes a MagicCode, an OpeCode (release instruction), and a session ID that are described later (see (H) of FIG. 10).

<1-2-2> Function of the Storage Device

A function configuration of the storage device 1 is described below with reference to FIGS. 2 to 4 and 8.

Before start of the processing according to the embodiment, the policy information table 33A as illustrated in FIG. 3 is created and registered to the memory 33 of the storage device 1 beforehand, for example, in accordance with the procedures C1 to C3 illustrated in FIG. 8. Here, information such as the following items (1) to (3) is associated with the policy information table 33A and registered to the policy information table 33A as policy information.

(1) A virtual machine name (virtual environments A or B) that is used to identify the virtual machine 2A or 2B to which a first write request (copy request) is issued in the host 2

(2) A copy target device name (“/dev/vda” or “/dev/vdb”) that is used to identify a target device of the copy request in each of the virtual machines 2A and 2B

(3) A copy source logical unit number (LUN: copy source information) and a copy destination LUN (copy destination information) of the target device of the copy request.

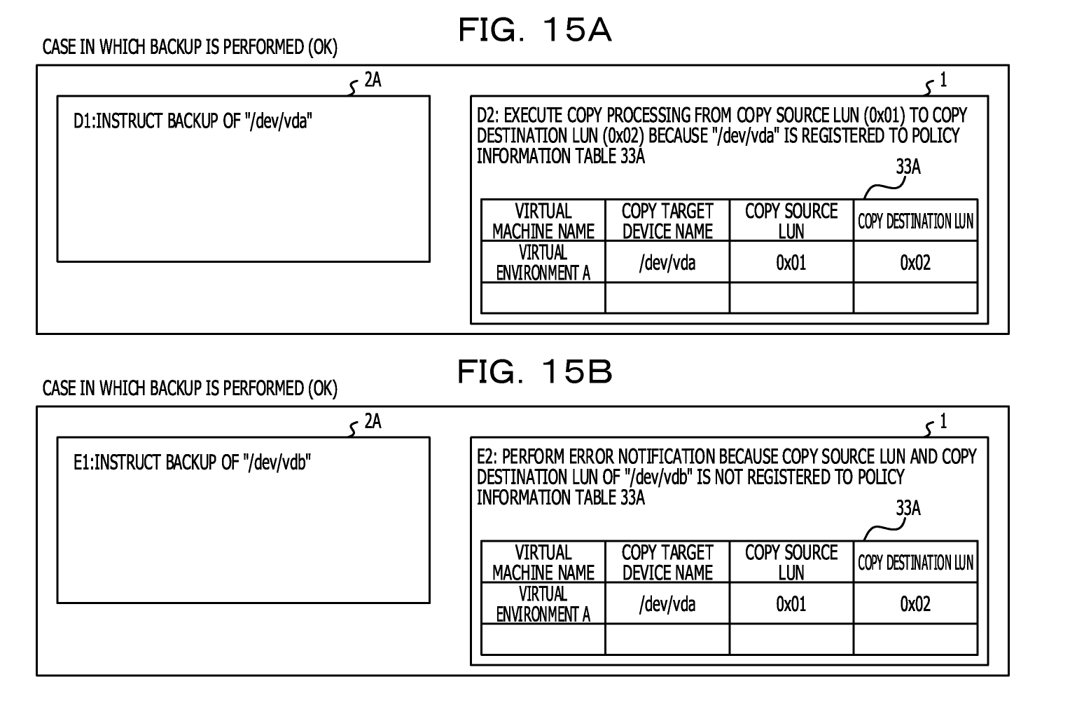

At this time, first, in the procedure C1, the virtual machine 2A (virtual environment A) transmits a device list of the virtual machine 2A to the storage device 1. The device list of the virtual machine 2A is a list of the names of devices in which backup is to be activated. The user of the virtual machine 2A transmits the device list of the virtual machine 2A and requests activation of backup of the virtual environment A to a storage administrator. In addition, in the procedure C2, in the storage device 1, a record is added to the policy information table 33A based on the device list that has been received from the virtual machine 2A. In the example illustrated in FIG. 8, two records are added to the policy information table 33A. The virtual environment A is associated with the device name “/dev/vda” and registered to the first record, and the virtual environment A is associated with the device name “/dev/vdb” and registered to the second record. At this point, in each of the records, a copy source LUN and a copy destination LUN are not registered yet. After that, in the procedure C3, a copy source LUN and a copy destination LUN are set by the storage administrator. As a result, the policy information table 33A is created and registered to the memory 33 beforehand. As described above, when the storage administrator sets the policy information, the virtual machine 2A may execute backup processing. The user of the virtual machine 2A may not be aware of information on the infrastructure. The backup processing (copy processing) is executed based on the information that is registered to the policy information table 33A, and error notification (error processing) is executed when information that is desired for the backup processing (for example, a copy source LUN and a copy destination LUN) is not set to the policy information table 33A. Here, the case is described above in which the policy information of the virtual machine 2A is set, but similarly, policy information of the virtual machine 2B (virtual environment B) is also registered to the policy information table 33A. In FIG. 8, the example of the policy information table 33A to which the two records are registered is illustrated, but in FIGS. 3 and 15, an example of the policy information table 33A to which one record is merely registered is illustrated.

The LUN is a number of a logical volume that is allowed to be uniquely identified in the storage device 1. The storage device 1 is constituted by a RAID format using a plurality of physical disks (HDDs 70), and a logical volume is seen as one physical disk from the host 2 side because the logical volume is cut out from the plurality of physical disks.

When the CPU 31 executes a program that is stored in the memory 33, the storage device 1 according to the embodiment functions as the reception unit 31A, the copy control unit 31B, a read control unit 31C, and a release control unit 31D.

The reception unit 31A builds the virtual control disk 70A as a virtual device, and accepts a write request (I/O request) to the virtual control disk 70A from each of the virtual machines 2A and 2B in the host 2, as a copy request to the HDD 70. Here, the virtual control disk 70A is a virtual disk that is used to issue a copy request by read/write I/O, and is seen as a regular disk on the HDD 70 from the virtual environments A and B. When first write data is written onto the specified write address (offset “0”) of the virtual control disk 70A in response to a first write request, the reception unit 31A refers to the written first write data. In addition, when a MagicCode is set to the first write data and an OpeCode corresponds to a copy instruction, the reception unit 31A accepts the first write request as a copy request. Here, the MagicCode is an identifier that indicates that the first write data is for the virtual control disk 70A in order to distinguish the first write data from a regular write I/O. The reception unit 31A executes the error processing such as the error notification when the MagicCode is not set.

When the reception unit 31A accepts the write request that includes a copy instruction as the OpeCode, the copy control unit 31B adds a record to the session information table 33B in the memory 33, which is illustrated in FIG. 4, performs allocation of a session identification (ID) that is used to identify a session for the above-describe copy instruction, and sets the allocated session ID to the added record. As described later, the session information table 33B associates a result of processing that corresponds to the copy request and return data to the copy request, with the session ID and stores the associated these pieces of data. In order to transfer information at a virtual address of the virtual control disk 70A, the session information table 33B associates an area that is used by the return data with the session ID and stores the associated are and session ID.

In addition, the copy control unit 31B determines whether or not a return zone offset that is included in the content of the copy request is already used, and executes the error processing such as the error notification when the return zone offset is already used. In addition, the copy control unit 31B sets a return zone offset to a virtual address field of the added record when the return zone offset is not used. Here, the return zone is a virtual return zone of the virtual control disk 70A, which is used to return the detail result of the operation that is specified by the OpeCode. As the return zone, there is no actual disk area, but return information is allowed to be returned to the virtual environments A and B through a regular read I/O by representing as if there is return information in the return zone for the host 2.

In addition, the copy control unit 31B determines the validity of the content of the copy request, based on the content of the copy request that is accepted by the reception unit 31A and the content of the policy information table 33A. In addition, the copy control unit 31B executes a copy instruction that corresponds to the copy request (first write request) when the copy control unit 31B determines that the content of the copy request is valid. At this time, the copy control unit 31B refers to the policy information table 33A, and determines that the content of the copy request is valid when the virtual machine name of the virtual machine 2A or 2B that issues the copy request, a copy target device name that is included in the content of the copy request, a copy source LUN, and a copy destination LUN are stored in the policy information table 33A.

When the reception unit 31A determines that the content of the copy request is valid, the copy control unit 31B reads the copy source LUN and the copy destination LUN that are associated with the copy target device name in the policy information table 33A. In addition, the copy control unit 31B executes the copy instruction from the read copy source LUN to the read copy destination LUN, and executes the copy processing (backup processing) from the copy source LUN to the copy destination LUN. After that, as illustrated in FIG. 4, the copy control unit 31B sets an execution result of the copy processing to the result area and the return data area in the added record of the session information table 33B.

At this time, as illustrated in FIG. 4, when the copy processing is completed successfully, for example, “1” is set to the result area of the session information table 33B, and when the copy processing is resulted in error termination, for example, “0” is set to the result area of the session information table 33B. In addition, as illustrated in FIG. 4, when the copy processing is completed successfully, nothing is set to the return data area of the session information table 33B, and an error content is set to the session information table 33B when the copy processing is resulted in error termination.

In addition, when the copy control unit 31B determines that the content of the copy request is valid, the copy control unit 31B executes the error processing such as the error notification. When the copy target device name is not registered to the policy information table 33A, when the copy target device name is registered but the copy source LUN and/or the copy destination LUN is not registered to the policy information table 33A, or the like, the copy control unit 31B determines that the content of the copy request is not valid.

When the reception unit 31A receives a read request to the virtual control disk 70A, which includes a read instruction as an OpeCode, the read control unit 31C executes the following processing. At this time, the read request includes storage area information that is information that is related to the result of a processing that corresponds to the copy request (specified read address and the specified data length) (see (C) and (E) of FIG. 10). The read control unit 31C refers to the session information table 33B, and controls the information that is related to the processing result (see (D) and (F) of FIG. 10) to be read from the HDD 70 and transmitted to the virtual machine 2A or 2B when the storage area information is registered as an virtual address of the session information table 33B.

In addition, when second write data is written onto the specified write address (offset “0”) of the virtual control disk 70A in response to a second write request, the reception unit 31A refers to the written second write data. In addition, when a MagicCode, a session ID, and an OpeCode that indicates a release instruction (release instruction information) are set to the second write data, the reception unit 31A accepts a second write request as a release request. Here, the MagicCode is an identifier that indicates that the second write data is for the virtual control device 70A in order to distinguish the second write data from a regular write I/O. The reception unit 31A executes the error processing such as the error notification when the MagicCode is not set to the second write data.

When the reception unit 31A accepts the second write request as a release request, the release control unit 31D controls a record of the session information table 33B, which is identified by the session ID, (session ID, result, return data, and area that stores a virtual address) to be released.

### 2 OPERATION OF THE INFORMATION PROCESSING SYSTEM ACCORDING TO THE EMBODIMENT

Operations of the information processing system 100 according to the embodiment (host 2 and storage device 1) that is configured as described above are described below with reference to FIGS. 9 to 15.

### 2-1 Operation of the Host (Virtual Machine)

First, the operation of the host 2 according to the embodiment (virtual machines 2A and 2B) is described below with reference to FIGS. 9 and 10. Here, FIG. 9 is a flowchart (Steps S1 to S8) illustrating the operation of each of the virtual machines 2A and 2B (virtual environments A and B) in the information processing system 100 according to the embodiment. FIG. 10 is a diagram illustrating a write/read instruction and data that are transmitted and received between the virtual machine 2A or 2B and the storage device 1 in the information processing system 100 according to the embodiment.

A procedure is described below in which the virtual machine 2A (virtual environment A) executes a copy request, a read request, or a release request to the storage device 1 using a regular write request/read request. The virtual machine 2B (virtual environment B) may execute a copy request, a read request, or a release request to the storage device 1 through a similar procedure.

When a copy request is executed, first, the virtual machine 2A issues a first write request (write I/O) to the offset “0” of the virtual control disk 70A (Step S1 in FIG. 9). In the first write request, as illustrated in (A) of FIG. 10, the offset “0” of the virtual control disk 70A is specified as a write address, and the data length of first write data illustrated in (B) of FIG. 10 is specified as a write data length.

The virtual machine 2A transmits the content of the copy request to the storage device 1, with the first write request, as first write data that is to be written by the first write request (Step S2 in FIG. 9). As illustrated in (B) of FIG. 10, in the first write data includes a MagicCode, an OpeCode that indicates a copy instruction, a copy target device name of the virtual machine 2A (for example, “/dev/vda”), and a return zone offset (for example, “0x0f”) of the virtual control disk 70A. The return zone offset indicates an area of the virtual control disk 70A, which stores data that is to be returned from the storage device 1 to the virtual machine 2A in response to the first write request (see (D) of FIG. 10), and is specified by the virtual machine 2A.

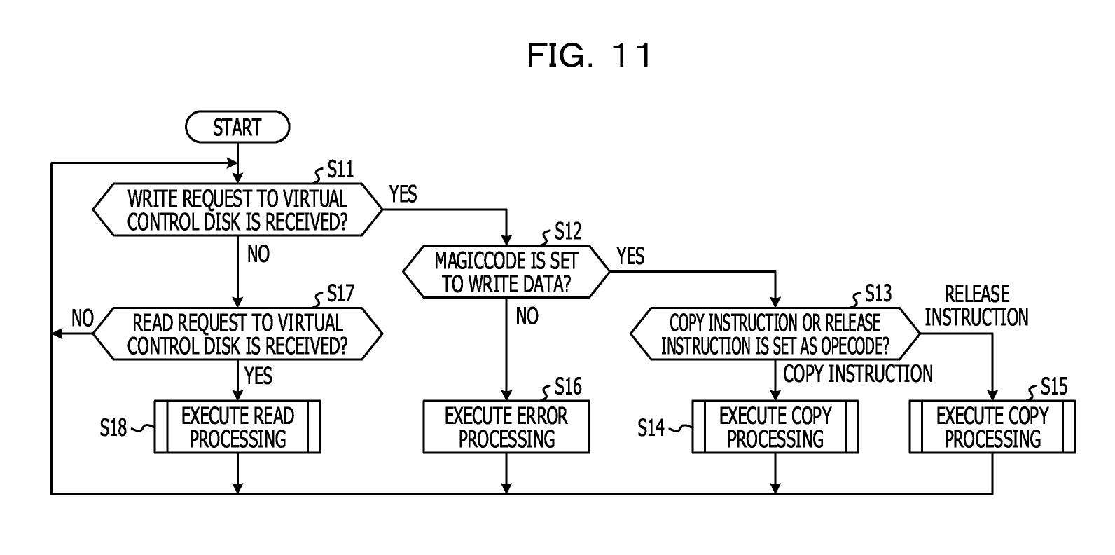

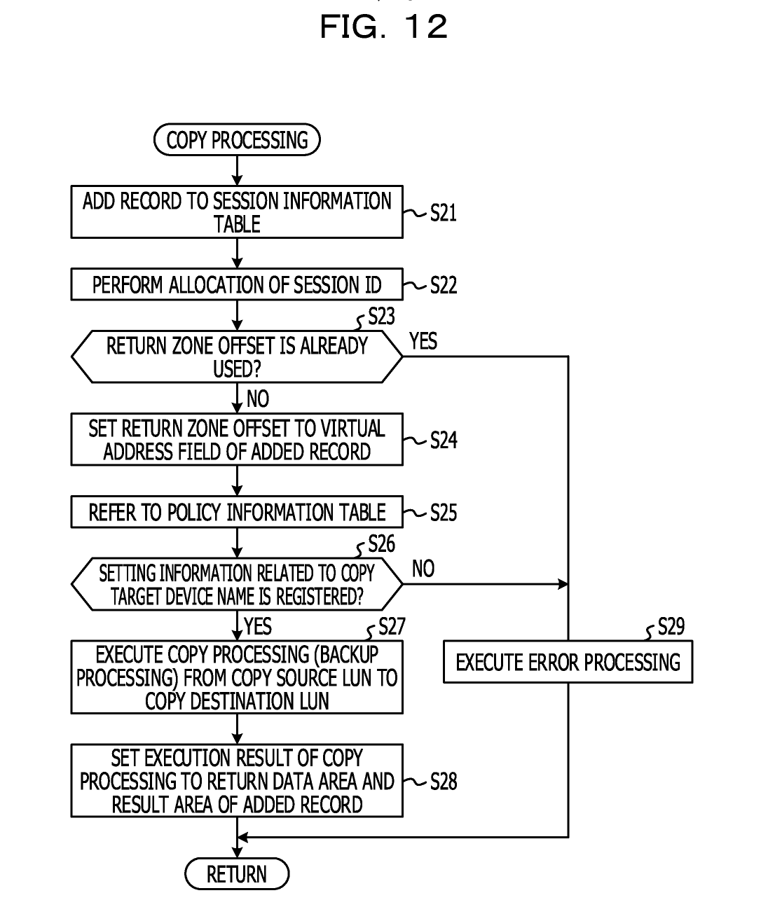

As described above, when the virtual machine 2A performs transmission of the first write data with the first write request, the first write data illustrated in (B) of FIG. 10 is written onto the offset “0” of the logical volume (virtual control disk 70A) in the storage device 1. In addition, on the storage device 1 side, the copy processing (see Step S14 of FIG. 11 and FIG. 12) is executed based on the first write data, and a session ID, a processing result, return data, and a virtual address (return zone offset) are registered to the session information table 33B.

In addition, on the storage device 1 side, data that is to be returned from the storage device 1 to the virtual machine 2A (see (D) of FIG. 10) is created and stored in the return zone offset “0x0f” that is specified by the first write data. As illustrated in (D) of FIG. 10, such data includes a MagicCode, a session ID that is allocated to the present copy request session, a processing result (1 or 0), a return zone offset (for example, “0x1f”), and a return zone length (for example, “0x10”).

Here, the return zone offset “0x1f” is set to a virtual address area of the session information table 33B, and indicates an area of the virtual control disk 70A, which stores return data that is to be returned from the storage device 1 to the virtual machine 2A in response to the read request illustrated in (E) of FIG. 10 (see (F) of FIG. 10). In addition, the return zone length“0x10” indicates the data length of the return data (see (F) of FIG. 10).

The virtual machine 2A issues a read request (read I/O) of data having a fixed length portion from the specific address of the virtual control disk 70A after issuing and transmitting of the first write request and the first write data (Step S3 in FIG. 9). In the read request that is issued as described above, as illustrated in (C) of FIG. 10, the return zone offset “0x0f” of the first write data is specified as a specific address (read address), and the data length of the data illustrated in (D) of FIG. 10 is specified as a fixed length (read data length).

On the side of the storage device 1 that receives the read request illustrated in (C) of FIG. 10 from the virtual machine 2A, the data having the fixed length portion, that is, the data illustrated in (D) of FIG. 10 is read from the return zone offset “0x0f” of the virtual control disk 70A and transmitted to the virtual machine 2A. In response to that, the virtual machine 2A receives the data illustrated in (D) of FIG. 10, which includes a session ID, a result, a return zone offset, and a return zone length (Step S4 in FIG. 9).

In addition, when the processing result in the received data is “0” (when the copy processing is resulted in error termination), the virtual machine 2A issues a read request (read I/O) in order to read return data that includes the error content from the storage device 1 (Step S5 in FIG. 9). As illustrated in (E) of FIG. 10, in the read request that is issued as described above, the return zone offset “0x1f” of the data that is received in Step S4 is specified as a read address, and the return zone length “0x10” of the data that is received in Step S4, that is, the data length of the return data illustrated in (E) of FIG. 10 is specified as a read data length.

On the side of the storage device 1 that receives the read request illustrated in (E) of FIG. 10 from the virtual machine 2A, the data having the return zone length “0x10” portion, that is, the return data illustrated in (F) of FIG. 10 is read from the return zone offset “0x1f” of the virtual control disk 70A and transmitted to the virtual machine 2A. In response to that, the virtual machine 2A receives the return data illustrated in (E) of FIG. 10 (Step S6 in FIG. 9).

When the virtual machine 2A receives the data illustrated in (D) and (F) of FIG. 10 from the storage device 1, the virtual machine 2A determines that the copy processing that has been instructed by the first write data is completed. In addition, the virtual machine 2A issues a second write request (write I/O) to the offset “0” of the virtual control disk 70A in order to release the area that has been used for the copy instruction in the storage device 1 (Step S7 in FIG. 9). As illustrated in (G) of FIG. 10, in the second write request, the offset “0” of the virtual control disk 70A is specified as a write address, and the data length of the second write data illustrated in (H) of FIG. 10 is specified as a write data length.

The virtual machine 2A transmits, with a second write request, the second write data that is to be written by the second write request, to the storage device 1 (Step S8 in FIG. 9). As illustrated in (H) of FIG. 10, the second write data includes a MagicCode, an OpeCode that indicates a release instruction, and a session ID that is used to identify a copy processing session of a release target. Here, the session ID is included in the data illustrated in (D) of FIG. 10, which is received in Step S4.

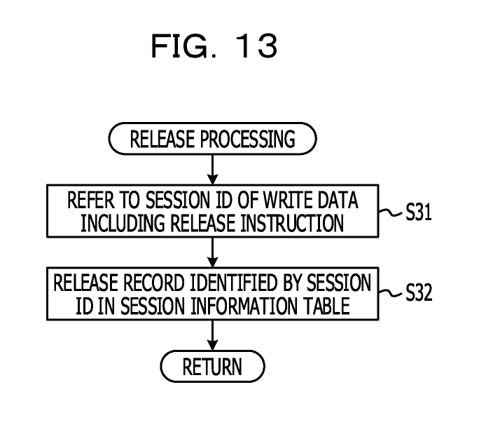

As described above, when the virtual machine 2A transmits the second write data with the second write request, the second write data as illustrated in (H) of FIG. 10 is written onto the offset “0” of the logical volume (virtual control disk 70A) in the storage device 1. In addition, on the storage device 1 side, the release processing (see Step S15 of FIG. 11, and FIG. 13) is executed based on the second write data, and a record that corresponds to a session ID that is specified by the second write data (session ID, processing result, return data, and virtual address) is released in the session information table 33B.

### 2-2 Operation of the Storage Device

The operation of the storage device 1 according to the embodiment is described below with reference to FIGS. 11 to 15.

First, the operation of the storage device 1 in the information processing system 100 according to the embodiment is described in accordance with the flowchart (Steps S11 to S18) illustrated in FIG. 11.

In the storage device 1, first, it is determined that a write request to the virtual control disk 70A is received (Step S11). At this time, when write data is written onto the specified write address (offset “0”) of the virtual control disk 70A in response to the write request, it is determined that the write request to the virtual control disk 70A is received. When the write data is written onto the offset “0” of the virtual control disk 70A (Yes in Step S11), the reception unit 31A refers to the write data and determines whether or not a MagicCode is set to the write data (Step S12). When the MagicCode is not set to the write data (No in Step S12), the reception unit 31A determines that the write data is not for the virtual control disk 70A, and executes the error processing such as the error notification for the virtual machine 2A (Step S16). After that, the CPU 31 returns the processing to Step S11.

In addition, when a MagicCode is set to the write data (Yes in Step S12), the reception unit 31A refers to the write data that has been written onto the offset “0” of the virtual control disk 70A, and determines whether a copy instruction or a release instruction is set as an OpeCode (Step S13). When a copy instruction is set as the OpeCode (copy instruction in Step S13), the reception unit 31A accepts a write request (first write request) as a copy request, and the copy control unit 31B executes the copy processing (Step S14). The copy processing that is executed in Step S14 is described later with reference to FIGS. 12 and 15. After that, the CPU 31 returns the processing to Step S11.

In addition, when a release instruction is set as the OpeCode (release instruction in Step S13), the reception unit 31A accepts a write request (second write request) as a release request, and the release control unit 31D executes release processing (Step S15). The release processing that is executed in Step S15 is described later with reference to FIG. 13. After that, the CPU 31 returns the processing to Step S11.

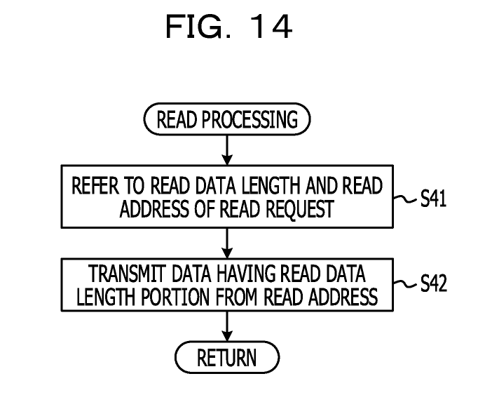

When a write request to the virtual control disk 70A is not received (No in Step S11), it is determined whether or not a read request to the virtual control disk 70A is received (Step S17). When a read request is not received (No in Step S17), the CPU 31 returns the processing to Step S11. In addition, when the reception unit 31A receives and accepts a read request to the virtual control disk 70A, the read control unit 31C executes read processing (Step S18). The read processing that is executed in Step S18 is described later with reference to FIG. 14. After that, the CPU 31 returns the processing to Step S11.

The copy processing according to the embodiment, which is executed in Step 14 of FIG. 11, is described below with reference to FIG. 15 in accordance with the flowchart (Steps S21 to S29) illustrated in FIG. 12. FIGS. 15A and 15B are diagrams illustrating the detailed validity determination of a command content using the policy information table 33A according to the embodiment.

When the reception unit 31A accepts a write request (first write request) that includes a copy instruction as an OpeCode, the copy control unit 31B adds a record to the session information table 33B in the memory 33 (Step S21). In addition, the copy control unit 31B performs allocation of a session ID that is used to identify a session that corresponds to the present copy instruction, and sets the allocated session ID to the added record (Step S22).

In addition, the copy control unit 31B determines whether or not a return zone offset that is included in the content of the copy request is already used (Step S23). When the return zone offset is already used (Yes in Step S23), the copy control unit 31B executes the error processing such as the error notification for the virtual machine 2A (Step S29). After that, the CPU 31 returns the processing to Step S11 of FIG. 11. In addition, when the return zone offset is not used (No in Step S23), the copy control unit 31B sets a return zone offset (for example, “0x0f”) to a virtual address field of the added record (Step S24).

In addition, the copy control unit 31B determines validity of the content of the copy request, based on the content of the copy request that has been accepted by the reception unit 31A and the content of the policy information table 33A (Steps S25 and S26). At this time, the copy control unit 31B refers to the content of the copy request that has been accepted by the reception unit 31A, and reads a copy target device name (for example, “/dev/vda”) from the copy request (Step S25). In addition, the copy control unit 31B determines the validity of the content of the copy request by determining whether or not setting information that is related to the read copy target device name is registered to the policy information table 33A (Step S26).

When the copy control unit 31B determines that the content of the copy request is valid (Yes in Step S26), the copy control unit 31B executes a copy instruction that corresponds to the copy request. That is, the copy control unit 31B refers to the policy information table 33A, and reads a copy source LUN and a copy destination LUN that are associated with the copy target device name in the policy information table 33A. The copy control unit 31B executes a copy instruction from the read copy source LUN to the read copy destination LUN, and executes the copy processing (backup processing) from the copy source LUN to the copy destination LUN (Step S27). In addition, as illustrated in FIG. 4, the copy control unit 31B sets an execution result of the copy processing to a return data area and a result area in the added record of the session information table 33B (Step S28). After that, the CPU 31 returns the processing to Step S11 of FIG. 11.

In addition, when a copy target device name is not registered to the policy information table 33A, or when a copy target device name is registered but a copy source LUN and/or a copy destination LUN is not registered to the policy information table 33A, or the like, the copy control unit 31B determines that the content of the copy request is not valid. When the copy control unit 31B determines that the content of the copy request is not valid (No in Step S26), the copy control unit 31B executes the error processing such as the error notification for the virtual machine 2A (Step S29). After that, the CPU 31 returns the processing to Step S11 of FIG. 11.

The validity determination of a command content using the policy information table 33A according to the embodiment is described in detail below with reference to FIGS. 15A and 15B.

First, when the virtual machine 2A instructs backup to a device having a copy target device name “/dev/vda”, write data that includes the copy target device name “/dev/vda” is written onto the virtual control device 70A of the storage device 1 (see D1 in FIG. 15A). At this time, to the policy information table 33A, the copy target device name “/dev/vda” of the virtual machine 2A is registered so as to be associated with a copy source LUN “0x01” and a copy destination LUN “0x02”. Therefore, the copy control unit 31B executes the copy processing (backup processing) for the copy source LUN “0x01” and the copy destination LUN “0x02” (see D2 in FIG. 15A).

In addition, when the virtual machine 2A instructs backup to a device having a copy target device name “/dev/vdb”, write data that includes the copy target device name “/dev/vdb” is written onto the virtual control device 70A of the storage device 1 (see E1 in FIG. 15B). At this time, to the policy information table 33A, a copy source LUN and a copy destination LUN of the copy target device name “/dev/vdb” of the virtual machine 2A are not registered. Therefore, the copy control unit 31B executes the error processing such as the error notification for the virtual machine 2A (see E2 in FIG. 15B).

Release processing according to the embodiment, which is executed in Step S15 of FIG. 11, is described below in accordance with the flowchart (Steps S31 and S32) illustrated in FIG. 13.

When the reception unit 31A accepts a second write request as a release request, the release control unit 31D refers to a session ID of the second write data (Step S31). In addition, the release control unit 31D controls a record that is identified by the referred session ID (session ID, result, return data, and area that stores a virtual address) to be released in the session information table 33B (Step S32).

The read processing according to the embodiment, which is executed in Step S18 of FIG. 11, is described below in accordance with the flowchart (Steps S41 and S42) illustrated in FIG. 14.

When the reception unit 31A accepts a read request to the virtual control disk 70A, which includes a read instruction as an OpeCode, the read control unit 31C refers to the read data length and the read address in the read request (Step S41). In addition, the read control unit 31C reads data having the read data length portion that is specified by the read request, from the read address that has been specified by the read request, and controls the read data to be transmitted to the virtual machine 2A (Step S42). As a result, for example, information on the processing result illustrated in (D) and (F) of FIG. 10 (return data and the like) is returned to the virtual machine 2A.

### 3 CONCLUSION

In the information processing system 100 according to the embodiment, in the storage device 1, the virtual control disk 70A that does not have the actual size is provided in the disk array (HDD 70). The virtual control disk 70A is coupled to the virtual environments (virtual machines 2A and 2B), and a copy instruction is written onto the virtual control disk 70A by a regular write I/O (first write request, that is, I/O request). Even in the virtual environment, the write I/O is not blocked by the hypervisor 2C. In the storage device 1, it is determined whether or not an OpeCode that is included in write data corresponds to a copy instruction, at timing at which writing to the virtual control disk 70A occurs, and the copy processing (backup processing) is actually executed when it is determined that the OpeCode corresponds to a copy instruction.

As described above, in the embodiment, a copy instruction from the user of the virtual machines 2A and 2B is received at the virtual control disk 70A. As a result, a backup instruction (copy instruction) may be executed from the virtual machines 2A and 2B to the storage device 1 without being affected by access limit of a specific command by the hypervisor 2C or the like, and without clearly disclosing the actual device name and the actual address. Thus, the copy instruction from the virtual environments 2A and 2B to the storage device 1 may be executed while the security is ensured similar to a regular environment. In addition, even in an environment such as public cloud in which a virtual environment is rented, backup may be performed in a state in which the security is ensured without disclosing information on the infrastructure.

At this time, in the embodiment, the user of the virtual environment requests activation of backup for the storage administrator beforehand, and the storage administrator that has accepted the request sets policy information to the policy information table 33A beforehand. In addition, when it is determined that the content of the copy request is validity, based on the policy information, in advance of execution of the copy processing, the copy processing (backup processing) is executed. As a result, in the virtual environment, backup management in which the security is ensured may be achieved. In addition, accesses from the plurality of the virtual machines 2A and 2B may have no influence on each other.

In addition, in the embodiment, a release instruction is written onto the virtual control disk 70A by a regular write I/O (second write request, that is, an I/O request). As a result, after the copy processing, the record of the session information table 33B, which has been used for the copy processing, may be identified by a session ID and released.

In addition, in the embodiment, a read request is issued to the virtual control disk 70A using a regular read I/O (read request, that is, I/O request). As a result, return data and the like (see (D) and (F) of FIG. 10) that are generated related to the copy processing (backup processing) may be transmitted from the storage device 1 to the virtual machines 2A and 2B.

### 4 OTHERS

The embodiments are described above, but the embodiments discussed herein are not limited to the above-described certain embodiments, and various modification and changes are allowed to be made without departing from the scope of the embodiments discussed herein.

All or a part of functions as the above-described reception unit 31A, copy control unit 31B, read control unit 31C, and release control unit 31D are achieved when a computer that includes a central processing unit (CPU), an information processing device, and various terminals executes a certain application program.

In addition, the above-described application program is provided so as to be stored, for example, in a computer readable recording medium such as a flexible disk, a compact disc (CD) that includes a compact disc-read-only memory (CD-ROM), a compact disc recordable (CD-R), a compact disc rewritable (CD-RW), a digital versatile disc (DVD) that includes a digital versatile disc-read-only memory (DVD-ROM), a digital versatile disc random access memory (DVD-RAM), a digital versatile disc recordable (DVD-R), a digital versatile disc rewritable (DVD-RW), a DVD+R, and a DVD+RW, and a blu-ray disc. In this case, the computer uses the program so as to read the program from the recording medium, and transfers and store the program in an internal storage device or an external storage device.

Here, the computer includes hardware and an OS and corresponds to the hardware that is operated under the control of the OS. In addition, when the hardware is operated by the application program alone without the OS, the hardware itself corresponds to the computer. The hardware includes at least a microprocessor such as a CPU, and a unit that reads the computer program that is recorded to the recording medium. The above-described application program includes a program code that causes the above-described computer to achieve functions as the reception unit 31A, the copy control unit 31B, the read control unit 31C, and the release control unit 31D. In addition, a part of the functions may be achieved by the OS instead of the application program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a processing device; and
a storage device that is accessed by the processing device, and wherein the storage device including:
a storage unit, and
a processor coupled to the storage unit and configured to:
build a virtual device,
determine an I/O request to the virtual device from the processing device, as a copy request to the storage unit, and
execute a copy instruction to the storage unit in response to the copy request.

2. The information processing system according to claim 1, wherein
the I/O request to the virtual device is issued from a virtual machine that is built in the processing device.

3. The information processing system according to claim 1, wherein
the I/O request to the virtual device is a first write request to the virtual device, the first write request indicating writing of first writing data to the virtual device, the first write data including a content of the copy request to the storage unit, and
the processor is configured to execute a copy instruction to the storage unit in accordance with the content of the copy request that is written onto the virtual device.

4. The information processing system according to claim 3, wherein
the processor is configured to execute processing in accordance with the first write request when an identifier indicating that the first write data is for the virtual device is set to the first write data.

5. The information processing system according to claim 3, wherein the processor is configured to:
determine validity of the content of the copy request based on the content of the copy request and policy information that is set beforehand, and
issue the copy instruction corresponding to the first write request when it is determined that the content of the copy request is valid.

6. The information processing system according to claim 5, wherein
the policy information includes a copy target device name that is used to identify a target device of the copy request in the processing device and correspondence information between copy source information and copy destination information of the target device of the copy request, and
the processor is configured to determine that the content of the copy request is valid when the copy target device name that is included in the content of the copy request is associated with the copy source information and the copy destination information and is recorded to the correspondence information.

7. The information processing system according to claim 6, wherein the processor is configured to:
read the copy source information and the copy destination information that are associated with the copy target device name, from the correspondence information, when it is determined that the content of the copy request is valid, and
execute a copy instruction to the storage unit based on the read copy source information and copy destination information.

8. The information processing system according to claim 1, wherein
the I/O request to the virtual device is a read request to the virtual device, which is used to specify area information of the virtual device, and the area information includes storage area information that is information on a result of a processing that corresponds to the copy request,
the processor is configured to:
read the information on the processing result from the storage unit based on the storage area information, and
transmit the read information on the processing result to the processing device.

9. The information processing system according to claim 1, wherein
the I/O request to the virtual device is a second write request to the virtual device, the second write request indicating writing of second write data to the virtual device, the second write data including session identification information identifying a session with respect to the copy request and release instruction information, and
the processor is configured to release an area that stores information on the session identified by the session identification information, based on an acceptance of the second write request including the release instruction information.

10. The information processing system according to claim 9, wherein
the processor is configured to execute processing in accordance with the second write request when an identifier indicating the second write data is for the virtual device is set to the second write data.

11. A storage device that is accessed by a processing device, the storage device comprising:
a storage unit; and
a processor coupled to the storage unit and configured to:
build a virtual device,
determine an I/O request to the virtual device from the processing device, as a copy request to the storage unit, and
execute a copy instruction to the storage unit in response to the copy request.

12. A backup method executed by an information processing system including a processing device and a storage device that is accessed by the processing device, the storage device including a storage unit, the backup method comprising:
building a virtual device;
determining an I/O request to the virtual device from the processing device, as a copy request to the storage unit, and
executing a copy instruction to the storage unit in response to the copy request.

13. The backup method according to claim 12, wherein
the I/O request to the virtual device is issued from a virtual machine that is built in the processing device.

14. The backup method according to claim 12, wherein
the I/O request to the virtual device is a first write request to the virtual device, the first write request indicating writing of first writing data to the virtual device, the first write data including a content of the copy request to the storage unit, and
the executing of the copy instruction executes the copy instruction in accordance with the content of the copy request that is written onto the virtual device.

15. The backup method according to claim 14, further comprising:
executing processing in accordance with the first write request when an identifier indicating that the first write data is for the virtual device is set to the first write data.

16. The backup method according to claim 14, further comprising:
determining validity of the content of the copy request based on the content of the copy request and policy information that is set beforehand, and
issuing the copy instruction corresponding to the first write request when it is determined that the content of the copy request is valid.

17. The backup method according to claim 16, wherein
the policy information includes a copy target device name that is used to identify a target device of the copy request in the processing device and correspondence information between copy source information and copy destination information of the target device of the copy request, and
the determining of validity of the content of the copy request determines that the content of the copy request is valid when the copy target device name that is included in the content of the copy request is associated with the copy source information and the copy destination information and is recorded to the correspondence information.

18. The backup method according to claim 12, wherein
the I/O request to the virtual device is a read request to the virtual device, which is used to specify area information of the virtual device, and the area information includes storage area information that is information on a result of a processing that corresponds to the copy request,
the backup method further comprising:
reading the information on the processing result from the storage unit based on the storage area information; and
transmitting the information on the processing result read by the reading to the processing device.

19. The backup method according to claim 12, wherein
the I/O request to the virtual device is a second write request to the virtual device, the second write request indicating writing of second write data to the virtual device, the second write data including session identification information identifying a session with respect to the copy request and release instruction information, and
the backup method further comprising:
releasing an area that stores information on the session identified by the session identification information, based on an acceptance of the second write request including the release instruction information.

20. The backup method according to claim 19, further comprising:
executing processing in accordance with the second write request when an identifier indicating the second write data is for the virtual device is set to the second write data.
